(19) United States
(12) Patent Application Publication
(10) Pub. No.: US 2009/0220828 A1
(43) Pub. Date: Sep. 3, 2009

(54) SYSTEM AND METHOD FOR FUEL CELL START UP

(75) Inventors: Michael T. Davis, Port Coquitlam (CA); Richard G. Fellows, Vancouver (CA); Mark K. Watson, Langley (CA)

Correspondence Address: SEED INTELLECTUAL PROPERTY LAW GROUP PLLC, 701 FIFTH AVE, SUITE 5400, SEATTLE, WA, 98104, US

(73) Assignee: BDF IP Holdings Ltd.

(21) Appl. No.: 12/293,074

(22) PCT Filed: Mar. 13, 2007
(86) PCT No.: PCT/US2007/006355

§ 371 Date: Jan. 7, 2009

Related U.S. Application Data
(60) Provisional application No. 60/783,100, filed on Mar. 15, 2006.

(51) Int. Cl. H01M 8/04; H01M 8/18

(52) U.S. Cl. 429/13; 429/22; 429/19

(57) ABSTRACT

Start up systems and methods for a fuel cell system are disclosed. The start up systems and methods include supplying a hydrogen containing fluid to both the cathode electrode and the anode electrode of the fuel cell at substantially the same time during a first stage in the start up, ceasing the supply of the hydrogen containing fluid to the cathode electrode during a second stage of the start up, and supplying an oxidant to the cathode electrode at a third stage in the start up of the fuel cell.

### BACKGROUND OF THE INVENTION

1. Field of the Invention

Fuel cells may be used to supply power in a wide variety of applications. Exemplary transportation applications include hybrid electric vehicles (HEV), electric vehicles (EV), Heavy Duty Vehicles (HDV) and Vehicles with 42-volt electrical systems. Exemplary stationary applications include backup power for telecommunications systems, uninterruptible power supplies (UPS), and distributed power generation applications.

Electrochemical fuel cells convert reactants, namely a fuel and oxidant, to generate electric power and reaction products. Electrochemical fuel cells generally employ an electrolyte disposed between two electrodes, namely a cathode and an anode.

2. Description of the Related Art

One type of electrochemical fuel cell is the proton exchange membrane (PEM) fuel cell. PEM fuel cells generally employ a membrane electrode assembly (MEA) comprising a solid polymer electrolyte or ion-exchange membrane disposed between two electrodes.

In a fuel cell, an MEA is typically interposed between two electrically conductive separator or fluid flow field plates that are substantially impermeable to the reactant fluid streams. The separator plates act as current collectors and may provide mechanical support for the MEA. In addition, the separator plates have channels, trenches, or the like formed therein which serve as paths to provide access for the fuel and the oxidant fluid streams to the anode and the cathode, respectively. Also, the fluid paths provide for the removal of reaction byproducts and depleted gases formed during operation of the fuel cell.

In a fuel cell stack, a plurality of fuel cells are connected together, typically in series but sometimes in parallel or a combination of series and parallel, to increase the overall output power of the fuel cell system. In such an arrangement, one side of a given separator plate may be referred to as an anode separator plate for one cell and the other side of the plate may be referred to as the cathode separator plate for the adjacent cell.

When a fuel cell has been shut down for a long period of time, the gas composition present at the cathode and anode flow fields of the fuel cell typically consists mainly of air. This may be due for example to air crossover through the membrane as well as air leaks in the seals and valves of the fuel cell system. On starting up such a fuel cell, adding hydrogen fuel to the anode electrode results in a wavefront as the air present at the anode is displaced by the hydrogen. This wavefront causes the cathode potential downstream of the wavefront to rise to a value that may contribute to corrosion of the cathode electrode.

Various solutions have been proposed to mitigate the above described problem. Some solutions have proposed purging the flow fields with inert gasses during the shut down operation of the fuel cell, or drawing an electrical load from the fuel cell during startup of the fuel cell to limit the cathode potential. These approaches to dealing with the described problem often give rise to substantially increased complexity and cost of the fuel cell system which is undesirable. US-2002-0076582-A1 proposes using an extremely rapid purging of the anode flow field upon start up with a hydrogen reducing fluid fuel so that air is purged from the anode flow field in no more than 1 second, or as quickly as no more than 0.05 seconds. This solution may reduce the corrosion effects, but has not proved effective in eliminating them.

U.S. Pat. No. 6,838,199-B2 proposes a method for starting up a fuel cell including the steps of: purging the cathode flow field with the reducing fluid fuel; then, directing the reducing fluid fuel to flow through the anode flow field; next, terminating flow of the fuel through the cathode flow field and directing an oxygen containing oxidant to flow through the cathode flow field; and connecting a primary load to the fuel cell so that electrical current flows from the fuel cell to the electrical load. This method merely shifts the corrosion problem from the cathode of the fuel cell to the anode of the fuel cell.

Solutions to eliminate or further minimize electrode corrosion upon startup of a fuel-cell are therefore desirable.

### BRIEF SUMMARY OF THE INVENTION

In one embodiment, a method for starting operation of a fuel cell system comprises supplying a fuel to both the anode electrode and the cathode electrode of the fuel cell system at substantially the same time during a first stage in the startup process, ceasing the supply of the fuel to the cathode electrode during a second stage in the startup process, and supplying an oxidant to the cathode electrode during a third stage in the startup process.

In another embodiment, a fuel cell system comprises an anode electrode with an adjacent anode flow field, a cathode electrode with an adjacent cathode flow field, a fuel supply device coupled to the anode flow field and coupleable to the cathode flow field, and a controller configured to control the fuel supply device to supply both the anode flow field and the cathode flow field with a fuel at substantially the same time during a start up of the fuel cell system.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram illustrating an embodiment of the present invention comprising a valve coupled to both the anode inlet and the cathode inlet of a fuel cell.

FIG. 2 is a schematic diagram illustrating an embodiment showing a container coupled to both the anode inlet and the cathode inlet of a fuel cell.

FIG. 3 is a schematic diagram illustrating an embodiment using a recirculation system coupled to both the anode and the cathode of a fuel cell.

FIG. 4 is a schematic diagram illustrating an embodiment using both a fuel recirculation system and an oxidant recirculation system coupled to the fuel cell.

FIG. 5 is a schematic diagram showing a typical fuel distribution through a fuel cell stack during startup.

FIG. 6 is a schematic diagram illustrating a possible hydrogen-air wavefront arising from implementation of an embodiment of the present invention.

FIG. 7 is a schematic diagram illustrating possible effects of introducing an oxidant into the cathode of a fuel cell after supplying fuel containing fluid into the cathode.

### DETAILED DESCRIPTION OF THE INVENTION

In the following description and enclosed drawings, certain specific details are set forth in order to provide a thorough understanding of various embodiments of the invention. One skilled in the art will understand, however, that the invention may be practiced without all of these details. In other instances, well-known structures associated with fuel cell systems have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the claimed invention.

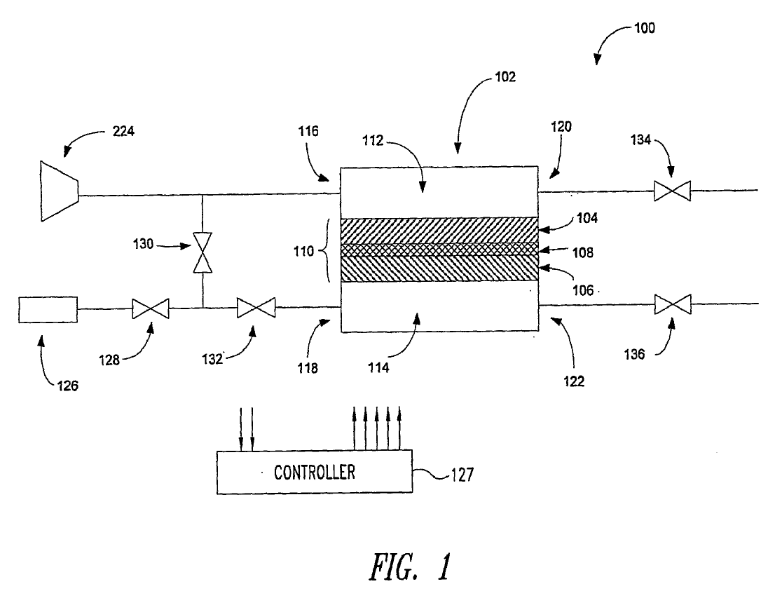

FIG. 1 illustrates a fuel cell system 100 according to one embodiment. A fuel cell 102 comprises an ion-exchange membrane 108 disposed between a cathode electrode 104 and an anode electrode 106. The assembly comprising the membrane 108, and the electrodes 104, 106 is referred to as a membrane electrode assembly (MEA) 110. Cathode flow field 112 and anode flow field 114, adjacent to the cathode electrode 104 and the anode electrode 106 respectively, allow an oxidant and a fuel or reactant to come into fluid contact with the electrodes 104, 106. The flow fields 112, 114 may comprise channels, trenches, or the like formed within separator plates (not shown) as described above.

The fuel cell system 100 further comprises cathode inlet 116 and anode inlet 118 to enable the introduction of the oxidant and fuel streams into the cathode flow field 112 and the anode flow field 114 respectively. Cathode outlet 120 and anode outlet 122 provide for the removal of reaction byproducts and depleted fluids formed during operation of the fuel cell.

Valves 134, 136 are coupled to the outlets 120, 122 to either regulate the pressure of the fluids within the fuel cell 102, or as purge valves, to expel the reaction byproducts and depleted fluids formed during operation of the fuel cell 102 from the fuel cell 102.

At a stage in the start up operation of the fuel cell system 100, a controller 127 operates valves 128, 130, and 132 in concert to supply fuel from the fuel source 126 to both the cathode electrode 104 and the anode electrode 106 at substantially the same time. For the purposes of this invention, this is defined as the first stage in the start up operation of the fuel cell system. It should however be noted that the controller 127 may take other actions during the start up of the fuel cell system either before, after, in-between, or simultaneously with the stages described in this disclosure. These actions may for example comprise: purging the electrodes 104, 106 with a passivating fluid, connecting an electrical load to the fuel cell, circulating cooling fluid through the fuel cell, and operating heaters, among other actions. While such activities are not described in detail, these and other start up actions are well known and persons of ordinary skill in the art can readily select suitable start up actions for a given application. The controller 127 may employ information (arrows pointing toward controller 127) received from sensors and monitors, and may provide control signals (arrows pointing away from controller 127) to various valves, switches, actuators, solenoids, relays, contactors, motors, pumps, fans, blowers, compressors and other equipment.

The timing of the actuation of the valves 128, 130, and 132 may depend on factors such as the relative volumes of the cathode flow field 112 and the anode flow field 114, as well as the volume of the piping leading to the inlets 116, 118, among other factors. Calculating the actual timing and sequence of the valve operations is well within the abilities of an individual of ordinary skill in the art using well established principles.

For example, assuming the volume of the cathode flow field 112 is equal to the volume of the anode flow field 114, and assuming the valves 130, 132 are placed close enough to the cathode inlet 116 and the anode inlet 118 that the volume of the piping between the valves 130, 132 and the inlets 116, 118 is negligible, operating valve 128 first, and then operating valves 130 and 132 at substantially the same time would supply the fuel to both the cathode electrode 104 and the anode electrode 106 at substantially the same time.

The presence of a fuel on a cathode electrode and an anode electrode at substantially the same time should provide symmetrical conditions at the cathode electrode and the anode electrode, which in turn should avoid the creation of a high potential region, which in turn contributes to the minimization or elimination of the corrosion problem previously mentioned. This is described in more detail below.

At some period after the fuel has been introduced into the cathode flow field 112, the controller 127 halts the supply of the fuel to the cathode flow field 112. This is defined as the second stage of the start up of the fuel cell system 100. This may be accomplished by, for example, closing valve 130. This period may be predefined, or may be calculated or otherwise determined by the controller 127 during operation of the fuel cell system.

In some embodiments, once the hydrogen-air wavefronts have been eliminated from the anode flow field 114 by the passage of the fuel through the anode flow field 114 (i.e., the air has been substantially expelled from the flow field, or has been thoroughly mixed in to the fuel gas so that a wavefront is no longer present), an oxidant may be supplied to the cathode flow field 112. This is defined as the third stage of the start up of the fuel cell system 100. It should be appreciated that the amount of time required to eliminate the hydrogen-air front on the anode electrode 106 may be calculated for a given fuel cell system, and therefore the various components described may be actuated for a pre-determined period of time.

Oxidant is provided to the cathode electrode 104 of the fuel cell 102 by an oxidant source 124. In some embodiments the oxidant source 124 may comprise a storage device such as oxygen tanks. In other embodiments the oxidant source 124 may comprise an active device such as an air compressor or an air blower, among others. In some embodiments the oxidant source 124 may further comprise various other components such as filters, two-way valves and/or check valves. In some embodiments the oxidant source 124 may include means to prevent the fuel from escaping to atmosphere or from contaminating the oxidant source 124 during the first stage of the start up of the fuel cell 102. For example, in embodiments where a compressor is used to supply oxidant to the fuel cell 102, the compressor might be operated at a low speed to inhibit the fuel from traveling towards the oxidant source 124, or to dilute the fuel entering the fuel cell 102.

Once the fuel is present at the anode electrode 106, and an oxidant is present at the cathode electrode 104, the fuel cell 102 may be ready to supply power to an external load (not shown), and the start up procedure is complete. In some embodiments it may be desirable to connect an electrical load (not shown) to the fuel cell 102 during some or all of the above described stages to further minimize the corrosion, or to produce more rapid heating of the fuel cell 102.

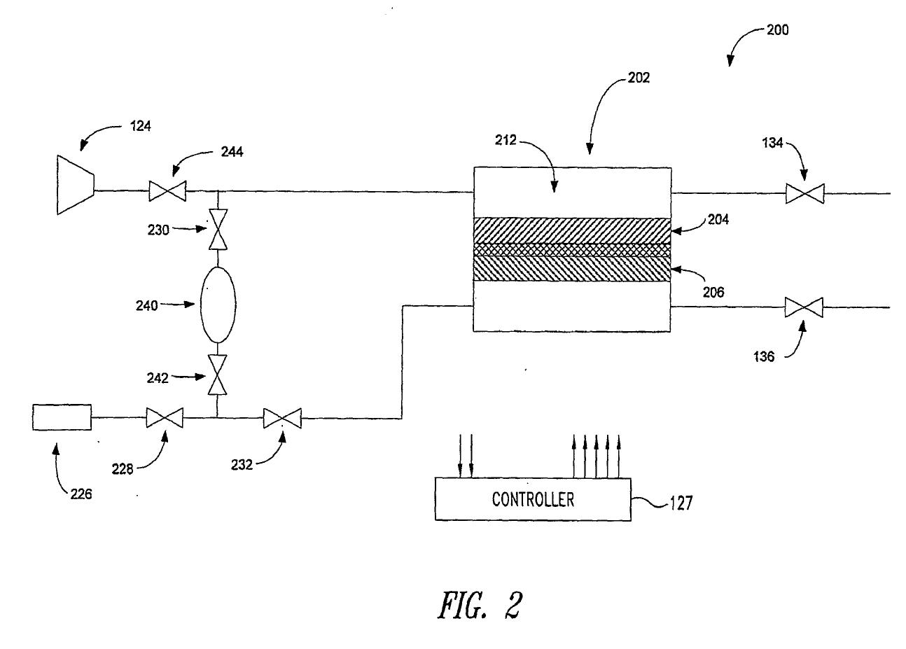

FIG. 2 shows an embodiment of a fuel cell system 200 including an accumulator 240. In this embodiment, the controller 127 first operates valves 228 and 242 to fill the accumulator 240 with a fuel supplied by the fuel source 226. Once sufficient fuel is accumulated in the accumulator 240, valve 242 is closed. On starting up the fuel cell 202, the controller 127 operates valves 230 and 232 to supply the fuel to both the cathode electrode 204 and to the anode electrode 206 at substantially the same time. The remainder of the start up operations may then duplicate the operations described above.

In some embodiments it may be desirable to supply the cathode electrode with a known volume of fuel during the start up process. For example, to prevent the exhaust of fuel from the fuel cell 202 to the atmosphere it may be desirable to cease the supply of the fuel to the cathode electrode 204 before the fuel completely fills the cathode flow field 212. Using an accumulator 240 as shown, can therefore be useful to supply a known quantity of fuel to the cathode electrode 204.

In some embodiments valve 244 may be used to isolate the oxidant source 224 from the cathode flow field 212 during some stages of the start up process, in order to prevent the fuel from contaminating the oxidant source 224 during the startup process.

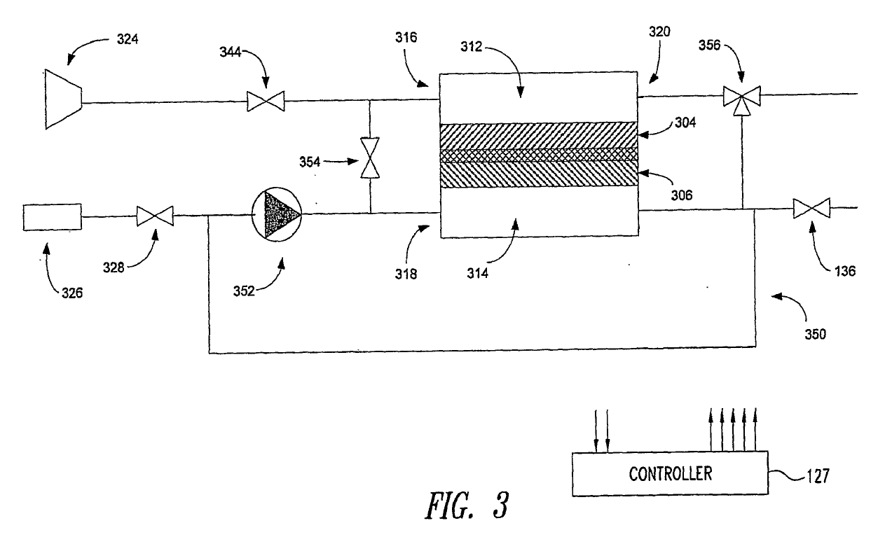

FIG. 3 illustrates another embodiment of the present invention. As shown in FIG. 3, a recirculation system 350 may be used to supply fuel to both the cathode electrode 304 and the anode electrode 306 at substantially the same time. The recirculation system 350 comprises a recirculation pump 352 to circulate fluids through the anode flow field 314 during normal operation. Alternatively, other devices may be used to achieve the same objectives as the recirculation pump 352 shown in FIG. 3. For example, in some embodiments the recirculation pump 352 may be replaced by a blower, a jet pump, a combination of these devices, or other suitable devices.

On start up, the controller 127 operates valve 328 to supply fuel from the fuel source 326 to the recirculation pump 352. The controller 127 then operates recirculation pump 352, and valves 354 and 356 to supply the fuel to both the cathode electrode 304 and the anode electrode 306 at substantially the same time. Three-way valve 356 is operated to direct the fluid exhausted from the cathode outlet 320 into the recirculation system 350 to be circulated through both the cathode flow field 312 and the anode flow field 314. In some embodiments it may be desirable to begin circulating the fluid already in the flow fields 312, 314 before operating valve 328 to supply the fuel to the system.

In some embodiments, valve 328 may be operated to only supply a limited amount of the fuel to the recirculation pump 352. For example, valve 328 may be operated to supply an amount of fuel to the recirculation pump 352 such that the concentration of hydrogen in the air present in flow fields 312, 314 remains below a threshold value (for example below a flammable limit of 4% hydrogen in air).

Similar to the examples above, once sufficient fuel has been introduced into the flow fields 312, 314, the valve 354 is operated to fluidly isolate the cathode inlet 316 from the anode inlet 318. Valve 356 is operated to isolate the cathode outlet 320 from the recirculation system 350, and may be further operated to exhaust any fluids from the cathode flow field 312 to atmosphere. Valve 344 is then operated to supply an oxidant from the oxidant source 324 to the cathode inlet 316.

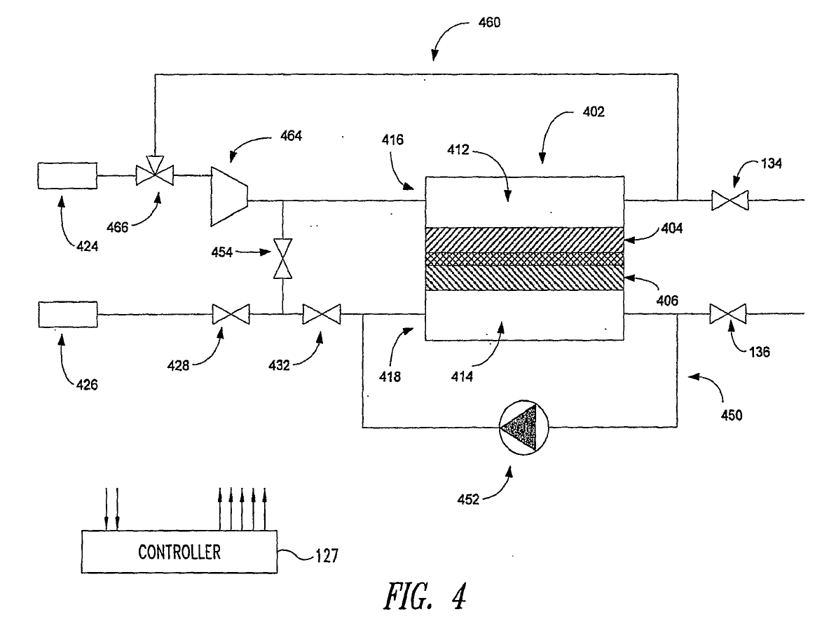

FIG. 4 illustrates an embodiment comprising an anode recirculation system 450 and a cathode recirculation system 460. The anode recirculation system 450 comprises a recirculation pump 452 to circulate fluids through the anode flow field 414 during normal operation, and the cathode recirculation system 460 comprises a blower 464 to circulate fluids through the anode flow field 412 during normal operation. Alternatively, other devices may be used to achieve the same objectives as the recirculation pump 452 and the blower 464 shown in FIG. 4. For example, in some embodiments the recirculation pump 452 and/or the blower 464 may be replaced by a blower, a jet pump, a combination of these devices, or other suitable devices.

On start up, the controller 127 operates valve 428 to supply a fuel from the fuel source 426 to the valves 432, 454. The controller 127 then operates valves 432, 454, recirculation pump 452, and blower 464 to supply the fuel to both the cathode electrode 404 and the anode electrode 406 at substantially the same time.

In some embodiments it may be desirable to begin circulating the fluid already in the flow fields 412, 414 before operating valves 432, 454 to supply the fuel to the fuel cell 402. In some embodiments it may be desirable to operate the recirculation pump 452 and the blower 464 at different speeds to vary the rate of recirculation of the fluids in recirculation systems 450, 460.

In some embodiments, valves 432, 454 may be operated to only supply a limited amount of the fuel to either or both the anode flow field 414 and the cathode flow field 412. For example, valves 432, 454 may be operated to supply an amount of fuel to the flow fields 412, 414 such that the concentration of hydrogen in the air present in flow fields 412, 414 remains below a threshold value (for example below a flammable limit of 4% hydrogen in air).

Similar to the examples above, once sufficient fuel has been introduced into the flow fields 412, 414, the valve 454 may be operated to fluidly isolate the cathode inlet 416 from the anode inlet 418.

Three-way valve 466 is then operated to supply an oxidant from the oxidant source 424 to the blower 464.

Valves 134, 136 are operated to exhaust any fluids from the flow fields 412, 414 to atmosphere as required. Valves 134, 136 may also be used to regulate the pressures of the fluids in the flow fields 412, 414.

Three-way valve 466 may be operated to vary the proportions of fluid recirculated through the cathode recirculation system 460, and the proportion of fluid introduced into the system from an oxidant source 424.

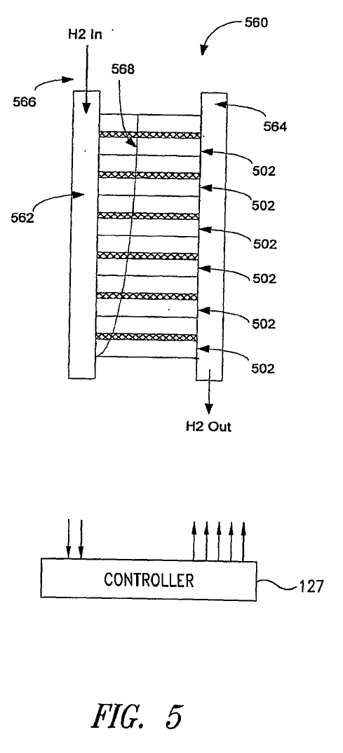

FIG. 5 illustrates a fuel cell stack 560 comprising a number of fuel cells 502. The fuel cell stack typically comprises a fuel inlet header 562, a fuel outlet header 564, and corresponding oxidant inlet and outlet headers (not shown). The fuel inlet header 562 provides fluid to each of the fuel cells 502. As fuel is typically introduced from an external source into a single section of the fuel inlet header 562 (for example at 566 on FIG. 5) a fuel distribution such as that shown by dotted line 568 might exist. For example, the fuel cell 502 closest to the fuel introduction point 566 might be 25% filled at the time fuel begins entering the fuel cell 502 furthest from the fuel introduction point 566. The fuel distribution 568 is largely affected by the design of the headers 562, 564 as well as the flow fields within the fuel cell stack 560. In some embodiments it is therefore desirable to design the fuel headers, the oxidant headers, the flow fields, and the control of the various components shown in FIGS. 1-4 in such a way so that, on start up, the fuel enters the cathode and anode flow fields of an individual fuel cell at substantially the same time.

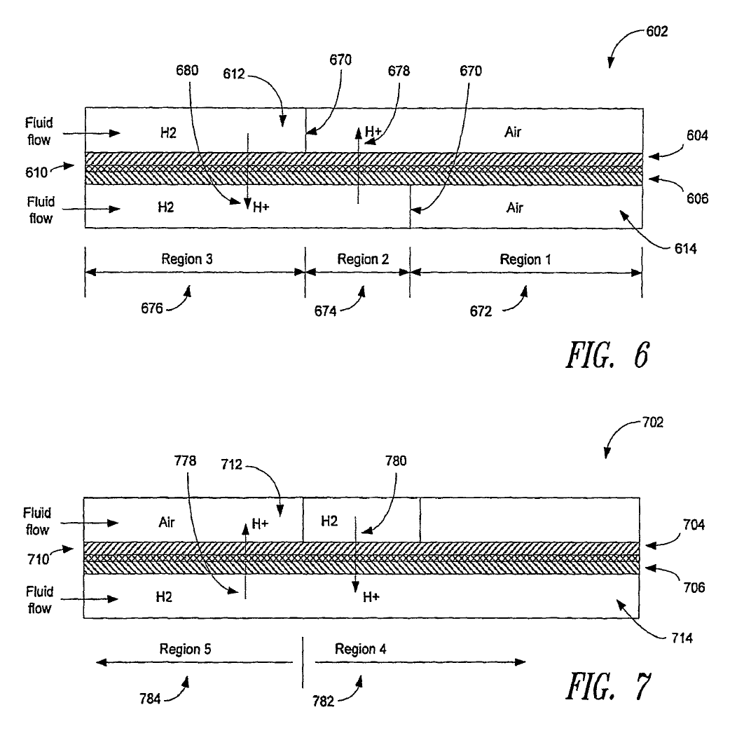

FIG. 6 shows the expected behavior of hydrogen-air wavefronts 670 present in the cathode flow field 612 and the anode flow field 614 of a fuel cell 602. Region 1 (672) denotes the region where air is present in the flow fields 612, 614 on both sides of the MEA 610. Region 2 (674) denotes a region where hydrogen is present on one electrode and air is present on the other electrode (i.e., the region between the wavefronts 670). Region 3 (676) denotes a region where hydrogen is present on both sides of the MEA 610. Currents established within region 2 (674), by proton transfer occurring at 678, should be balanced by reverse currents established within region 3 (676) due to proton transfer 680 back to the anode electrode 606, which maintains charge neutrality. This pumping of hydrogen from the cathode electrode 604 to the anode electrode 606 should prevent the buildup of a large cell voltage, which should in turn minimize or eliminate corrosion due to this mechanism.

As can be seen in FIG. 6, without being bound by theory, it is therefore predicted that electrode corrosion can be minimized by causing hydrogen-air wavefronts to be present in both the cathode flow field 612 and the anode flow field 614 at the same time. Electrode corrosion typically occurs in the electrode opposite the hydrogen-air wavefront, and by causing hydrogen-air wavefronts to be present on both electrodes, reverse currents may be generated that may minimize the electrode corrosion.

In some embodiments, the hydrogen-air wavefronts do not progress through the flow fields 612, 614 at the same rate. In further embodiments there might be a delay between the formation of a wavefront in one flow field, and the formation of a wavefront in the opposite flow field.

Therefore, as used herein and in the appended claims, supplying fuel to both flow fields at substantially the same time is defined as supplying fuel to both flow fields so that at some period of time, hydrogen-air wavefronts exist within both flow fields.

A suitable fuel for the purposes of this invention comprises a hydrogen containing fluid. The fuel could for example comprise a substantially pure hydrogen gas, a hydrogen-rich fluid such as reformate, methanol, or other suitable compounds containing hydrogen.

FIG. 7 shows the expected behavior of a fuel cell when an oxidant (in this case air) is introduced into the cathode flow field 712 at a stage after the supply of the fuel to the cathode flow field 712 has ceased. Region 4 (782) denotes a region where hydrogen is present on both sides of the MEA 710. In region 4 (782) remaining hydrogen in the cathode flow field 712 is recovered by hydrogen pumping into the anode flow field 714, as depicted by the arrow 780. Region 5 (784) denotes the oxidant (in this case air) in the cathode flow field 712 introduced after the supply of the fuel to the cathode has ceased. In some embodiments the oxidant is only introduced into the cathode flow field 712 after the anode flow field 714 is completely filled with the fuel (i.e., no hydrogen-air wavefront exists in the anode flow field 714). In region 5 (784) protons travel from the anode electrode 706 to the cathode electrode 704, denoted by the arrow 778. This represents the normal, power producing, operation of the fuel cell 702. Once the anode flow field 714 is substantially filled with fuel, and the cathode flow field 712 is substantially filled with the oxidant, the fuel cell 702 may be ready for normal operation, i.e., the fuel cell 702 may be ready to provide power to a load (not shown).

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, parts of the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the methods and control mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

Although specific embodiments of and examples for a fuel cell system and methods are described herein for illustrative purposes, various equivalent modifications can be made without departing from the spirit and scope of the disclosure, as will be recognized by those skilled in the relevant art.

For example, those skilled in the art will recognize that the embodiments disclosed herein, in whole or in part, can be equivalently implemented using a wide variety of standard components and circuits. For example three-way valves may be replaced by two two-way valves. Two-way valves may be replaced by check valves or other devices chosen to fulfill a similar purpose. Designing the circuitry and/or hardware and/or control strategies would be well within the skill of one of ordinary skill in the art in light of this disclosure.

The various embodiments described above can be combined to provide further embodiments.

These and other changes can be made to the invention in light of the above-detailed description. In general, in the following claims, the terms used should not be construed to limit the invention to the specific embodiments disclosed in the specification and the claims, but should be construed to include all fuel cell systems. Accordingly; the invention is not limited by the disclosure, but instead its scope is to be determined entirely by the following claims.

1. A method for starting operation of a fuel cell system comprising an anode electrode and a cathode electrode, the method comprising:
supplying a fuel to both the anode electrode and the cathode electrode at substantially the same time during a first stage;
ceasing the supply of the fuel to the cathode electrode at a second stage; and
supplying an oxidant to the cathode electrode at a third stage.

2. The method of claim 1, wherein ceasing the supply of the fuel to the cathode electrode comprises ceasing the supply of the fuel to the cathode electrode before the fuel has contacted the entire length of the cathode electrode.

3. The method of claim 1, wherein the fuel cell system further comprises a fuel recirculation system comprising a recirculation pump for circulating the fuel through an anode flow field in fluid communication with the anode electrode and coupleable to circulate the fuel through a cathode flow field in fluid communication with the cathode electrode, and wherein supplying the fuel to both the anode electrode and the cathode electrode at substantially the same time comprises operating the fuel recirculation system to supply the fuel to both the anode electrode and the cathode electrode at substantially the same time.

4. The method of claim 1, wherein the fuel cell system further comprises an accumulator device for receiving a volume of fuel from a fuel source, the accumulator device coupleable to supply at least a portion of the volume to the cathode electrode, and wherein supplying the fuel to both the anode electrode and the cathode electrode at substantially the same time comprises operating the accumulator device to supply the fuel to both the anode electrode and the cathode electrode at substantially the same time.

5. A fuel cell system comprising:
a membrane electrode assembly comprising a cathode electrode and an anode electrode;
a cathode flow field in fluid communication with the cathode electrode;
an anode flow field in fluid communication with the anode electrode;
a fuel supply device coupled to the anode flow field and coupleable to the cathode flow field; and
a controller configured to selectively control the fuel supply device to supply a fuel to both the cathode flow field and the anode flow field at substantially the same time during the start up of the fuel cell system.

6. The system of claim 5 wherein the controller is further configured to cease the supply of the fuel to the cathode flow field before the fuel has contacted the entire length of the cathode electrode.

7. The system of claim 5 further comprising:
an anode inlet coupled to supply the fuel from a fuel source to the anode flow field;
a cathode inlet coupled to supply a fluid to the cathode flow field; and
wherein the fuel supply device comprises a valve in fluid communication with the anode inlet and in fluid communication with the cathode inlet, and wherein the controller is configured to selectively operate the valve to supply the fuel to both the anode flow field and the cathode flow field at substantially the same time during the start up of the fuel cell system.

8. The system of claim 7 wherein the controller is configured to selectively operate the valve to supply the fuel to both the anode flow field and the cathode flow field at substantially the same time during a first stage in the start up of the fuel cell system, and wherein the controller is further configured to operate the valve to cease supplying the fuel to the cathode flow field during a second stage in the start up of the fuel cell system.

9. The system of claim 8, further comprising:
an oxidant source coupleable to the cathode inlet and operable to supply an oxidant to the cathode flow field during a third stage in the start up of the fuel cell system.

10. The system of claim 5, further comprising:
a cathode inlet coupled to supply a fluid to the cathode flow field; and
wherein the fuel supply device comprises an accumulator for receiving a volume of fuel from a fuel source, the accumulator coupleable to a cathode inlet for selectively supplying at least a portion of the fuel volume thereto.

11. The system of claim 5, further comprising:
an oxidant supply device coupleable to supply an oxygen containing fluid to the cathode flow field; and wherein the controller is configured to:
selectively control the fuel supply device to supply the fuel to both the cathode flow field and the anode flow field at substantially the same time during a first stage in the start up of the fuel cell system;
cease the supply of the fuel to the cathode flow field at a second stage in the start up of the fuel cell system; and
operate the oxidant supply device to supply the oxygen containing fluid to the cathode flow field at a third stage in the start up of the fuel cell system.

12. The system of claim 5 wherein the fuel supply device comprises a fuel recirculation loop for circulating the fuel through the anode flow field and coupleable to the cathode flow field.

13. The system of claim 12 wherein the fuel supply device comprises at least one valve configured to couple the cathode flow field thereto, and wherein the controller is further configured to selectively control the valve to supply the fuel to both the anode flow field and the cathode flow field at substantially the same time during the start up of the fuel cell system.

14. The system of claim 13 wherein the controller is further configured to control the valve to fluidly isolate the cathode flow field from the fuel recirculation loop at least during a period following the first stage in the start up of the fuel cell system.

15. The system of claim 14, further comprising:
an oxidant recirculation loop for circulating fluid through the cathode flow field.

16. The system of claim 15 wherein the controller is further configured to control the oxidant recirculation loop to supply the fuel to both the anode flow field and the cathode flow field at substantially the same time during the startup of the fuel cell system.

17. A system for starting a fuel cell power plant comprising:
means for supplying a fuel to both an anode electrode of the fuel cell and to a cathode electrode of the fuel cell at substantially the same time during a first stage;
means for ceasing the supply of the fuel to the cathode electrode at a second stage following the first stage; and
means for supplying an oxidant to the cathode electrode at a third stage.

18. The system of claim 17, wherein means for ceasing the supply of the fuel to the cathode electrode comprises means for ceasing the supply of the fuel to the cathode electrode before the fuel has contacted the entire length of the cathode electrode.
